(19) United States
(12) Patent Application Publication
(10) Pub. No.: US 2018/0374025 A1
(43) Pub. Date: Dec. 27, 2018

(54) METHODS AND SYSTEMS FOR DETERMINING PERSONA OF PARTICIPANTS BY THE PARTICIPANT USE OF A SOFTWARE PRODUCT

(71) Applicant: salesforce.com, inc., San Francisco, CA (US)

(72) Inventors: Nalini Kotamraju, Oakland, CA (US); Rebecca Sherrill, San Leandro, CA (US); Alyssa Vincent-Hill, Berkeley, CA (US); Yakaira Nunez, New Orleans, LA (US)

(73) Assignee: salesforce.com, inc., San Francisco, CA (US)

(21) Appl. No.: 15/631,110

(22) Filed: Jun. 23, 2017

(51) Int. Cl. G06Q 10/06; G06Q 10/10; G06F 9/44; G06N 99/00

(52) U.S. Cl. CPC G06Q 10/06398; G06N 99/005; G06F 8/77; G06Q 10/1053

(57) ABSTRACT

A method and system for processing data received by a participant use of a software product to identify a persona by participant use. The method includes generating a survey for identifying a plurality of tasks performed by each participant using the software product independent of a role defined for the participant in an organization. Next, receiving data by the survey from a set of responses related to tasks of the participant use of the software product and not in accordance with the set of similar functionalities defined by the organization. Further, quantifying the data of the survey into clusters using algorithmic solutions for associating the clusters with core behaviors of each of the participants to redefine a role of the participant. Then determining, from a plurality of personas, a particular persona to be associated with each participant in accordance with a redefined role of the participant in the organization.

### TECHNICAL FIELD

Embodiments of the subject matter described herein relate generally to defining roles of users of a software product. More particularly, embodiments of the subject matter relate to methods and systems for using data for identifying tasks performed by users of the software product independent of a role previously defined for the user in an organization and for redefining the role of the user based on the user use of the software product to determine therefrom a particular persona of the user by the redefined role.

### BACKGROUND

Organizations in general spend significant time and resources in defining roles of employees in a methodical and structured process. Often, job descriptions are formulated using a top down methodology where participants at the higher levels of a hierarchical pyramid are assigned tasks and responsibilities which are in turn divided, distributed or funneled down to subordinates reporting to these higher-level participants. In conjunction with job responsibilities, titles or roles are assigned to these subordinates. For example, in large organizations, significant numbers of subordinates are grouped together with similar titles and job descriptions even though these subordinates on a daily basis perform different tasks and undertake different responsibilities. In other words, subordinates who form the bulk of the employees in an organization are classified homogeneously and accorded similar job titles because such job titles and defined roles are based on projected or perceived responsibilities from a top down framework without actual understanding of the daily tasks performed by the employee. One reason this occurs is because there are limited tools that are convenient and available for assessing employee roles in hindsight or in a bottom up methodology that allows for assessments of the daily set of tasks afforded to an individual employee in the individual's role defined by the organization.

Accordingly, it is desirable to create a persona identification app using a bottom up formulation methodology of using empirical data such as survey data of participants using a software product for analyzing data of daily tasks afforded to each participate to define more clearly the participant's employee role, by the data of the participants use of the software product, in an organization.

It is desirable to redefine roles of employees in organizations based not on the job descriptions afforded these employees but actual daily tasks performed by the employees using the survey data of each participant employees use of a software product and to further better quantify and segregate a prior otherwise similar role classification of the participant employees based on results of the survey data associated with the software product use.

In other instances, it is desired to quantify the survey data using algorithmic solutions based on core behaviors and to associate the results with a particular persona from a set of personas of each of the participants by a participant's actual use of the software product irrespective of other activities in an organization.

Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is an exemplary diagram illustrating the persona identification app system in accordance with an embodiment;

FIG. 2 is an exemplary diagram illustrating a persona app client and server system for capturing data of participants use in the persona identification app system in accordance with an embodiment;

FIG. 3 is an exemplary diagram illustrating a survey questionnaire for data collection in the persona identification app system in accordance with an embodiment;

FIG. 4 is an exemplary diagram illustrating business process steps for data collection in the persona identification app system in accordance with an embodiment;

FIG. 5 is an exemplary diagram illustrating tasks for persona identification for data collection in the persona identification app system in accordance with an embodiment;

FIG. 6 is an exemplary diagram illustrating a particular persona and attributes in the persona identification app system in accordance with an embodiment;

FIG. 7 is an exemplary diagram illustrating titles not corresponding to persona in the persona identification app system in accordance with an embodiment;

FIG. 8 is an exemplary flowchart illustrating user steps for identifying persona in the persona identification app system in accordance with an embodiment; and

FIG. 9 is a schematic block diagram of a multi-tenant computing environment for use in conjunction with the persona identification app system in accordance with an embodiment.

### DETAILED DESCRIPTION

Often business processes are complex and fuzzy, hence employees that perform such business processes are often classified with similar or the same job titles and likewise share similar or same job descriptions. For example, employees who are similarly grouped are thought of by others in the organization as performing similar tasks and having the same types of skills. However, this is likely not the case. Moreover, because of the likelihood of this grouping scheme being consistently followed throughout an organization, this results in larger and larger groupings of employees with a similar or identical classification and job title. Furthermore, as a result of this grouping what fails to occur is any further quantifying of this group to better illustrate the employees' different skills and roles. Hence, employees in this grouping are then generally thought of unfairly as a homogenous group within an organization each offering the same contributions to the organization. That is, the organization perceives little differences between employees in such groupings and this may result in improper realizations that particular employees are easily interchangeable to the organizations overall goals.

Hence, the fundamental issue of defining similar roles by similar titles and job descriptions of large groups of employees can result in a plethora of negativities carried through for each employee, such as the following: failures to properly identify the tasks that the employee is actually performing, particularly those tasks that are performed on a regular basis which are different; failures of properly recognizing unique job tasks performed by subsets of employees; and failures to recognize critical points in a business process that require only distinct employee assistance and cannot be fulfilled by the greater homogenous majority.

Hence, it is desirable to provide a methodology to capture data about the tasks the employee performs routinely by tying employee tasks performed to the use of software apps. Hence, capturing task data performed by an employee who is identified as a participant subscriber to the software app and who conducts much of his or her daily task with the software app allows for a bottom up approach of employee role identification. That is, it is desirable to have data which is generated by the employees who are participants in the survey and partake in using the software app, for analysis using algorithmic solutions results to better quantify individual employee tasks and identify tasks performed through the employee participant's app use. As explained earlier, such task data as well as meta data from the app itself can be linked to a particular persona. Finally, appropriate user interfaces may be used to display the captured data and related analysis to understand the participant employee.

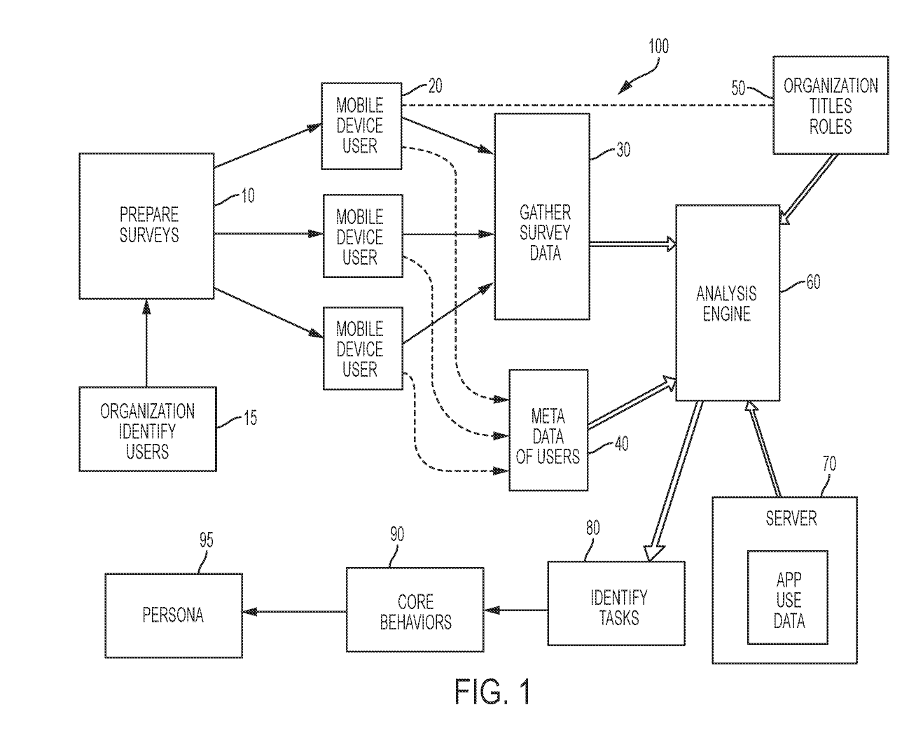

With a reference to FIG. 1, FIG. 1 is an exemplary diagram for generating and receiving data in the persona app system in accordance with an embodiment. Briefly, as explained earlier, fundamental to the persona app system is the gathering of data and identifying of the class of employees who are participants in the use of the app software. The persona app system 100 includes surveys 10 which are prepared in conjunction with users identified by the organization 15. That is, the participants of the survey are identified by the organization 15 and the survey is sent electronically to each of the participants identified. While in the exemplary embodiment, the data is generated by the participant use of the software app; that is much of the data or insight about the participants is gathered by the survey which has been sent to users who have been identified as users not only by the software use but also from a particular classification or job title in an organization. The data is derived from the participants filling out the survey. The survey is one mode of data capture and there are other modes of data collection and other tools to collect the data that may be employed. For example, the data may be derived by machine data from the mobile device 20 employed by the participant to access the software app, and/or the data may be derived by an application downloading templates and filling out the templates and uploading the templates. Also, social media type apps may be accessed to supplement the data. In other instances, prior histories of employees who are not the participants in the present survey and may or may not be part of the organization maybe used to augment the data set.

In the particular instance, the survey data is gathered by a processing module 30 and sent for further processing to an analysis engine 60. The analysis engine may reside in the cloud or at a server and may be part of the local ecosystem or part of the organization's ecosystem. Further, the analysis engine 60 may have accessibility to further information 50 of the organization at remote databases and may utilize a flexible data structure or tabular structure that allows for transcoding of heterogenous data types for inclusion in the data set and further analysis. In addition, the software app may reside in part or in whole at a server 70 that may reside on a different server platform than the analysis engine 60. For example, the analysis engine 60 may reside on a third-party server with a completely different platform from the software app 75 residing on the server 70. The analysis engine 60 may use various algorithmic solutions, more specifically algorithms relating to clustering to identify tasks 80. Once the tasks 80 are identified, the core behaviors 90 prescribed to each of the participants may be identified. A set of roles that were previously defined based on the organization descriptions and top down modeling, as a result of the clustering and identified tasks may now be redefined by the identified tasks for the role.

In general, when identifying and categorizing behavior in an efficient manner there are subjective decisions that must be made. Therefore, a plethora of data related to individual activity behavior including an individual's daily types of activities and times spent on such daily activities is required for accuracy. To effectively craft user personas, a large volume of data is generated that addresses both in-app usage and real-life routines for identifying data sets of commonalities and a corresponding number of optimum attributes for the crafted user personas. That is, once the core behaviors 90 by large data sets are identified using various grouping or clustering solutions, these core behaviors 90 may be crafted bottom up by the data clustering in a manner to match or substantially match a particular persona of a set of personas 95 by one or more clusters that have been formulated. While in the present disclosure, there is disclosure of a limited number of a set of personas 95, this number many be increased and changed. In fact, data sets derived in the bottom up formulations of a particular set of personas in one execution may, after additions or changes in the persona attributes, result in different personas or different sets of persona. That is, in an exemplary embodiment, the persona 95 may be considered a composite sketch of a target market based on validated commonalities rather than assumptions that informs content strategy to drive productive engagements. Once the initial persona has been identified, a variety of data collection methods are used to further the development of the personas. Typically interviews, focus groups, and observations are used to gain further understanding on the identified personas. For example, in interviews, a participant may be asked to describe a time when he or she needed something. This type of interview is useful as it may identify how the person used a facility. The interview, for example, may either validate a current persona description or facilitate any changes to the persona.

In accordance with a typical implementation, the persona 95 may include nine parts or segments for representing daily routines of objectives, problems, orientation, obstacles, questions, preferences, keywords, and engagement scenarios. Likewise, core behaviors 90 may be added to, deleted, or modified, and such changes in the core behaviors 90 will affect the personas 95 identified. In an exemplary embodiment, the business pipe-line may also undergo changes resulting in different tasks 80 identified for each participant, the data collected will reflect the changes, and the data is directly attributable to the tasks of the business pipeline.

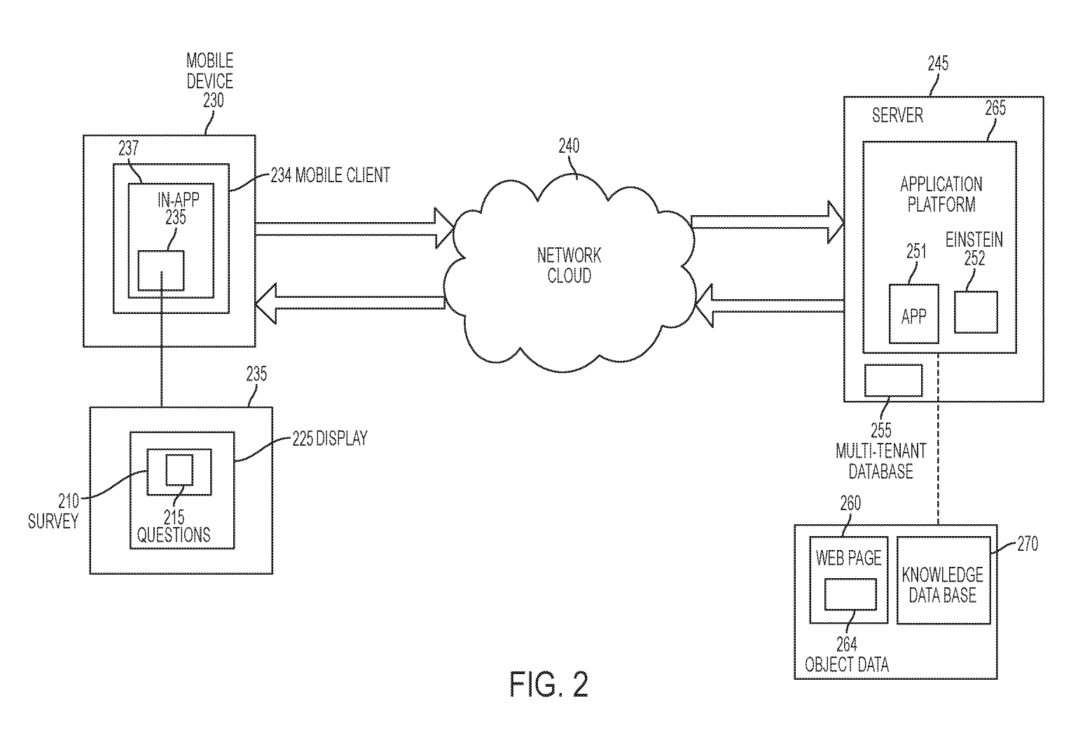

With a reference to FIG. 2, FIG. 2 is an exemplary embodiment of the persona app identification system diagram in accordance with an embodiment. The survey 210 is sent to a set of subscribers of a software app, usually via a mobile device 230, though in the alternative a desktop or laptop or any variety of computer devices with similar processing and display capabilities may receive the survey 210. The survey 210 may include a set of questions 215. The questions 215 can be considered a manner of extracting and identifying data related to the following: use of the software app, how the employee spends time during the day, tasks performed by the employee, behavior of the employee, personality of the employee etc. The questions allow for an increase in the understanding of how users see work that is beyond usage logs, bug reports filed, or features requested. In other words, the questions 215 give a more complete understanding of the user usage in everyday real-life scenarios that mimic daily work routines.

In an exemplary embodiment, a user may answer in the affirmative or non-affirmative to questions on the survey, or choose from multiple choice examples. The questions may be in the form of hypotheticals, analogies, or real world examples, and may be asked directly or indirectly. As such, the questions of the survey 210 include a significant number of possibilities but are reduced based on history and prior feedback. In addition, machine learning and artificial intelligence applications may be employed to search remote databases, identify patterns and model data sets in attempts to augment data derived from the sets of questions.

As an example, the participant would view the set of questions 215 on the display 237 of the mobile device 230 during a session. In an alternate exemplary embodiment, the participant may view the set of questions 215 on a desktop or laptop type device (not shown) instead of viewing or using the mobile device 230. The user may be given immediate feedback after completion of the survey 210 via the mobile device 230. Such feedback may include insights into the users' persona, behavior, or task performed and may also include feedback in relation to other participants having similar roles to show differences to the user. In certain instances, the user may desire to make changes to the questions 215 and the in-app 235 may be configured to allow for changes, or may allow for options of changes for the user. While the survey 210 is being answered via input by the participant, other means of input to the survey may also be used. For example, voice responses via natural language processing solutions may be used in conjunction with the in-app 235 of the mobile client 234. After survey data is entered, the survey data is uplinked or streamed via a network cloud to a server for analysis.

With a continued reference to FIG. 2, a cloud based network system or platform may be used where the mobile device 230 is communicating via a network cloud 240 to a server 245 for supporting an app which operates on-demand by communicating via the network cloud 240 to the mobile device 230 and which is hosted on a hosted app platform on a server 245. The network cloud 240 can include interconnected networks including both wired and wireless networks for enabling communications of the mobile device 230 via a mobile client 234 to the server app 251 hosted by server 245. For example, wireless networks may use a cellular-based communication infrastructure that includes cellular protocols such as code division multiple access (CDMA), time division multiple access (TDMA), global system for mobile communication (GSM), general packet radio service (GPRS), wide band code division multiple access (WCDMA) and similar others. Additionally, wired networks include communication channels such as the IEEE 802.11 standard better known as Wi-Fi®, the IEEE 802.16 standard better known as WiMAX®, and the IEEE 802.15.1 better known as BLUETOOTH®. The network cloud 240 allows access to communication protocols and application programming interfaces that enable real-time video streaming and capture at remote servers over connections

The mobile device 230 includes the mobile client 234 which may use a mobile software development kit “SDK” platform. This SDK platform can provide one step activation of an on-demand services via the in app 235 such as shown here of the mobile client 234 for activating the on-demand service such as the persona identification app of the present disclosure. The mobile device 230 may include any mobile or connected computing device including “wearable mobile devices” having an operating system capable of running mobile apps individually or in conjunction with other mobile or connected devices. Examples of “wearable mobile devices” include GOOGLE® GLASS™ and ANDROID® watches. Typically, the device will have capabilities such as a display screen, a microphone, speakers and may have associated keyboard functionalities or even a touchscreen providing a virtual keyboard as well as buttons or icons on a display screen. Many such devices can connect to the internet and interconnect with other devices via Wi-Fi, Bluetooth or other near field communication (NFC) protocols.

The mobile client 234 may additionally include other in apps 235 as well as SDK app platform tools and further can be configurable to enable downloading and updating of the SDK app platform tools. In addition, the mobile client 234 uses an SDK platform which may be configurable for a multitude of mobile operating systems including ANDROID®, APPLE® iOS, GOOGLE® ANDROID®, Research in Motion's BLACKBERRY OS, NOKIA's SYMBIAN, HEWLET_PACKARD®'s WEBOS (formerly PALM® OS) and MICROSOFT®'s WINDOWS Phone OS

The in app 235 of the mobile client 234 provided on the SDK platform can be found and downloaded by communicating with an on-line application market platform for apps and in-apps which is configured for the identifying, downloading and distribution of apps which are prebuilt. One such example is the SALESFORCE APPEXCHANGE® which is an online application market platform for apps and in-apps where the downloading, and installing of the pre-built apps and components such as an in app 235 for the mobile client 234 with persona identification app features.

In addition, these on-line application market platforms include “snap-in” agents for incorporation in the pre-built apps that are made available. The in-app 235 may be configured as a “snap-in” agent where the snap-in agent is considered by the name to be a complete SDK packages that allows for “easy to drop” enablement in the mobile client 234 or into webpages.

The server 245 acts as a host and includes the server app 251 that is configured for access by an application platform 265. The application platform 265 can be configured as a platform as a service (“PaaS) that provides a host of features to develop, test, deploy, host and maintain-applications in the same integrated development environment of the application platform. Additionally, the application platform 265 may be part of a multi-tenant architecture where multiple concurrent users utilize the same development applications installed on the application platform 265. Also, by utilizing the multi-tenant architecture in conjunction with the application platform 265 integration with web services and databases via common standards and communication tools can be configured. As an example, SALESFORCE SERVICECLOUD® is an application platform residing on the server 245 that hosts the server app 251 and may host all the varying services needed to fulfil the application development process of the server app 251. The SALESFORCE SERVICECLOUD® as an example, may provide web based user interface creation tools to help to create, modify, test and deploy different UI scenarios of the server app 251.

The application platform 265 includes applications relating to the server app 251. The server app 251 is an application that communications with the mobile client 234, more specifically provides linking for data communications to the mobile client 234 for multimedia data capture and streaming to the server 245. The server app 251 may include other applications in communication and data discovery for accessing a multi-tenant database 255 as an example, in a multi-tenant database system. In addition, the server app 251 may include components configurable to include user-interfaces (UI) to display a webpage 260 created or potentially alternative webpage configurations for selection and viewing. In an exemplary embodiment, the display of the webpage 260 may present UIs for displaying the survey results. The SALESFORCE SERVICECLOUD® platform is an application platform 265 that can host applications for creating webpages of UIs for communication with an in-app application 235 of the mobile client 234.

With continuing reference to FIG. 2, the display of the webpage 260 includes object data 264 which may include the survey results displayed by configurations of components forming UIs of the survey data results. Additionally, the application platform 265 has access to other databases for information retrieval which may include a knowledge database 270 that has artificial intelligence functionality 252. In an exemplary embodiment, the SALESFORCE® EINSTEIN™ data discovery app may include data discovery functionality that can be used with data from a SALESFORCE® app for collecting additional survey type of data and can allow for training of deep learning models to recognize and classify data sets of the survey data received.

In addition, the user can search for the answers using the knowledge database 270 which may be part of the multi-tenant database architecture allowing for communication with the mobile clients 234 about the survey. The knowledge database 270 may include an object data repository configured to allow the user to browse for information relating to user personas and send that information to the webpage 260. In addition, the application platform 265 can access a multi-tenant database 255 which is part of the multi-tenant architecture. The multi-tenant database 255 allows for enterprise customer access, and the application platform 265 may be given access to the multi-tenant database and made dependent upon differing factors such as a session ID associated with the persona identification app session.

With a continued reference to FIG. 2, the mobile device 230 includes the survey 210 and hosts the in app 235 which may also include a “snap-in” agent with an UI configured like a button for initiating or terminating a persona identification app's execution when the app is executing varies steps of the survey 210 and questions 215. The UI button could be shown on a display 225 with the button UI designated as an object within the display 225. The display 225 illustrated with survey 210 may also include a UI were other types of media, i.e., any kind of information can be viewed or transmitted by an in-app 235. The survey 210 may reside on a host such as a mobile device 230 which is different and therefore can be considered agnostic and configurable to the mobile device 230 which performs the hosting. Additionally, the survey 210 can be configured to reside in part or be presented in part on other interconnected devices. An example of this multi-device hosting would be interconnections of smart phones coupled with wearable devices where the display maybe found on an interconnected device or both the mobile and interconnected device.

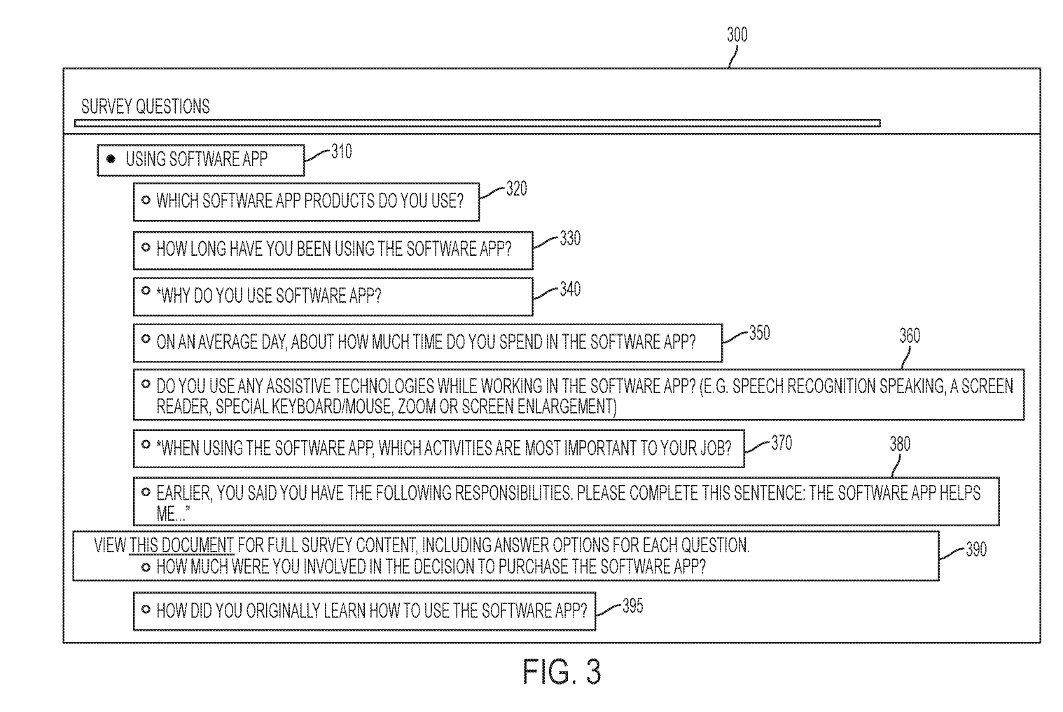

With a reference to FIG. 3, FIG. 3 is an exemplary diagram illustrating a survey questionnaire for data collection in the persona identification app system in accordance with an embodiment. In an exemplary embodiment, the survey questionnaire 300 may include a set of questions directed to the software app use at 310 by the participants. The software app may be a multitude of app types including a SaaS app, a cloud app, a server hosted app, and a combination of a client, a cloud and a server hosted app in which the app can be used by users from a multitude of locations as well as accessed by different devices. The questions are subjective in nature and gained by empirical testing. While it is contemplated that the questions in the questionnaire correspond to an environment of the subscriber user group identified; this may not always be the case, and different or outlawing questions or sets of questions outside of a norm may be used. For example, particular outside the norm questions may be generated specifically for identifying unique or singular attributes of use or time spent using the software app. The questionnaire, in this example, includes questions such as the following: which software app products do you use? at 320, how long have you been using the software app? at 330, how do you use the software app? at 340, on an average day how much time do you spend in the software app? at 350, do you use any assistive technologies while working in the software app? at 360, and when using the software app, which activities are most important to your job? at 370. The questionnaire includes alternate forms of conjugate type questions such as: earlier, you said you have the following responsibilities. Please complete this sentence the software app helps? at 380. In addition, the questionnaire may be linked to answer options by a link at 390. Finally, the questionnaire may include competitor insight questions such as, how did you originally learn to use the software product? at 395.

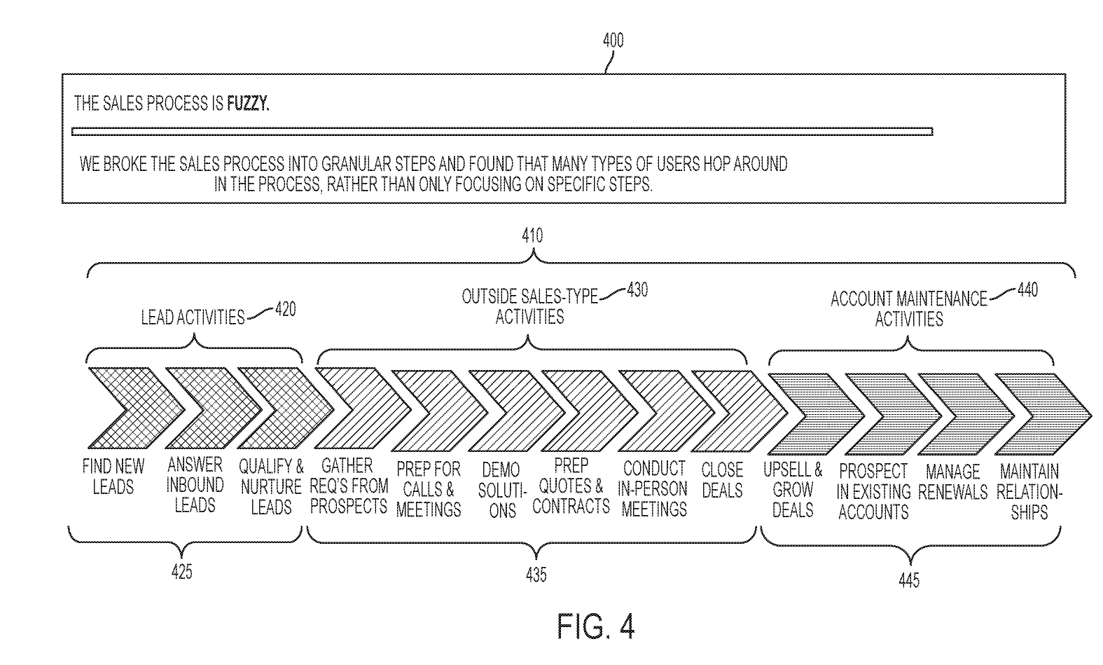

With a reference to FIG. 4, FIG. 4 is an exemplary diagram illustrating business process steps for data collection in the persona identification app system in accordance with an embodiment. In an exemplary embodiment, the sales process is shown in a sales process diagram 400. The sales process is a fuzzy set of tasks as shown by the fuzzy pipeline at 410. That is, each task may not be clear in the task itself or how the task is different from a former task or subsequent task in the pipeline. The sales process may include lead activities at 420, outside sales type activities at 430, and account maintenance activities at 440. This three-part pipeline is characterized by the user of a bottom up data collection methodology of performing empirical testing that identifies and segments an otherwise fuzzy sales process into particular activities. For example, the lead activities at 420 may be further segmented into the following: finding new leads, answering inbound leads, qualifying leads, and nurturing leads at 425. The outside sales type activities may be further segmented as follows: gathering requirements from prospects, preparing for calls and meetings, demonstrating solutions, preparing quotes and contracts, conducting in-person meetings, and closing deals at 435. Finally, the account maintenance activities at 440 may be segmented and categorized as follows: upselling and growing deals, prospecting in existing accounts, managing renewals, and maintaining relationships at 445.

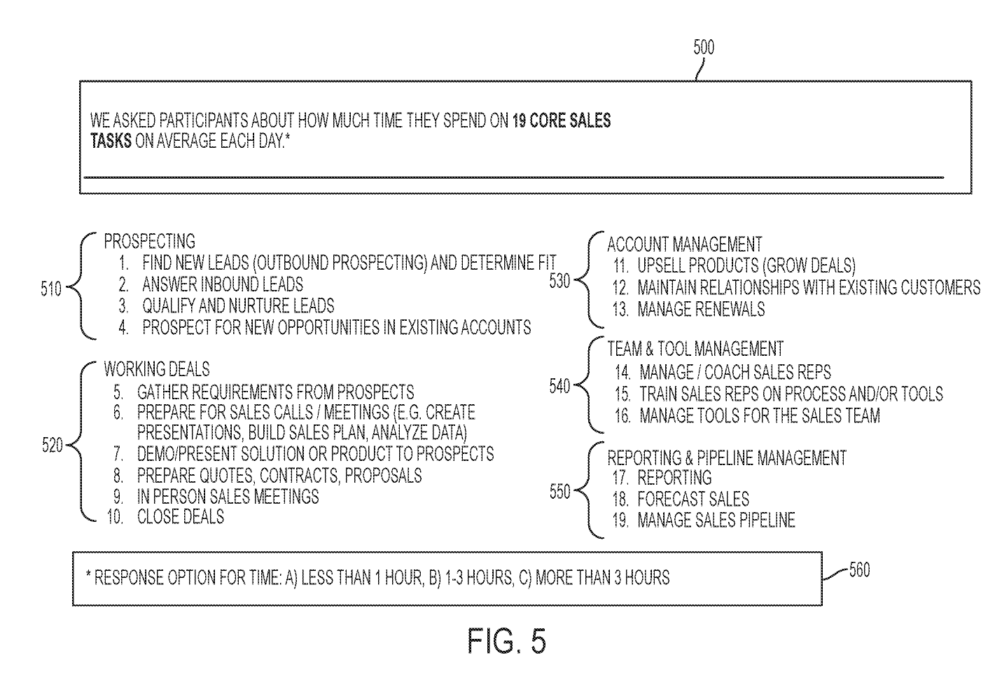

With a reference to FIG. 5, FIG. 5 is an exemplary diagram illustrating tasks for data collection in the persona identification app system in accordance with an embodiment. In the exemplary embodiment of a participant in a sales role, the participant time is quantified into nineteen core sales tasks at 500 with a response option for how much time is spent on each of the core sales tasks. The tasks quantified are as follows: prospecting at 500, working deals at 520, account management at 530, team and tool management at 540, and reporting at 550. Additionally, in FIG. 5, the participant time when prospecting includes as follows: (1) finding leads, (2) answering inbound leads, (3) qualify and nurture leads, and (4) prospecting for new opportunities. Further, each task is further quantified as follows: for working deals at 520, the participant time includes: (5) gathering requirements, (6) preparing sales calls and meetings, (7) demonstrating and presenting solutions to prospects, (8) preparing quotes, (9) in person sales meetings, and (10) closing deals. For the task of accounts account management at 530, the participant time is spent as follows: (11) upselling products, (2) maintaining relationships, and (13) managing renewals. For the task of team and tool management at 540, the participant time is spent as follows: (14) managing and coaching sales representatives, (15) training sales representations on processes and/or tools, and (16) managing tools for the sales team. Finally, for the task of reporting at 550, the participant time is spent as follows: (17) reporting, (18) forecasting sales, and (19) managing the sales pipelines. Additionally, the response time for each of the tasks is pre-set in time periods of one hour, one to three hours, and three of more hours at 560 where one of the time periods best suited for a given task is selected by the user who is performing the task. Hence, again the time period data for each task is formulated in a bottom up methodology by the user's own selection of time spent and not projections of time to be spent by higher management in an organization.

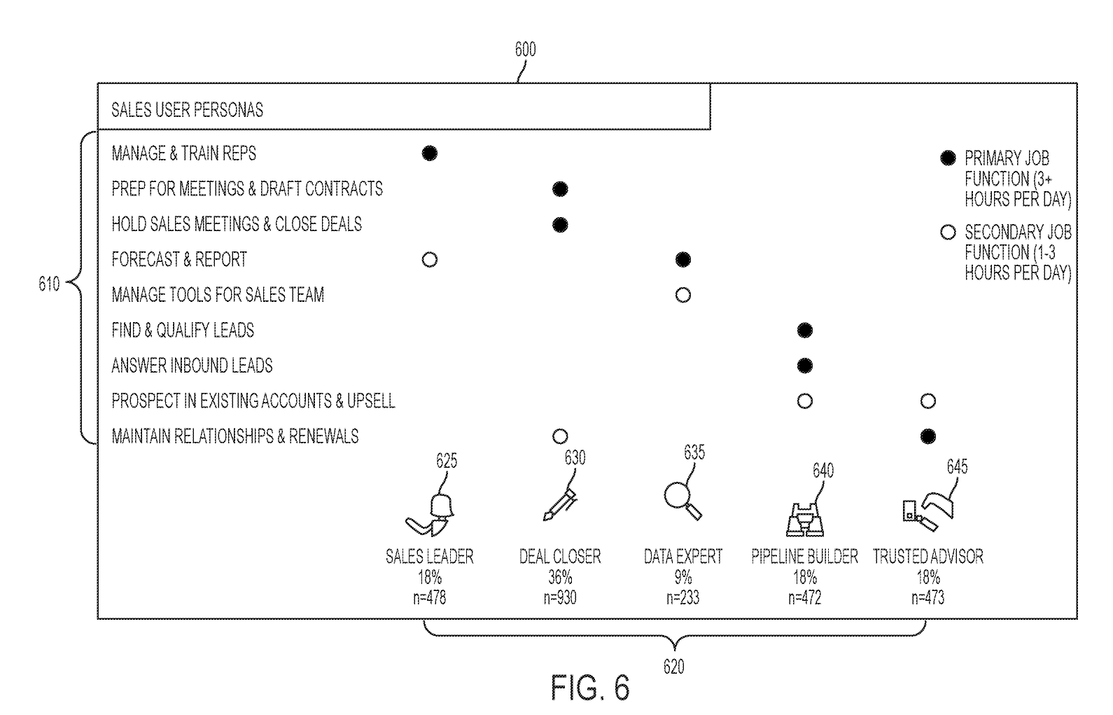

With a reference to FIG. 6, FIG. 6 is an exemplary diagram illustrating a particular persona and the attributes in the persona identification app system in accordance with an embodiment. The exemplary embodiment of FIG. 6 shows a sales user persona and job functions that correspond to the sales user persona. The participant by a data analysis of a participant set of data generated is compared to a sales user persona 600 and five other personas. That is, out of the five particular personas of a sales leader at 625, a deal closer at 630, a data expert at 635, a pipeline builder at 640 and a trusted advisor at 645 the sales user persona by the data analysis more closely matches the participant by the time the participant spends for each of the job functions.

For each of the personas, determinations are performed by various solutions using data received in a bottom up manner from the surveys completed by the users as well as from meta data of the software product generated by user access and data derived from the participant use as a subscriber of the software product. At 610, the data is categorized into a multiple number of areas. Some exemplary categories are as follows: managing and training reps, prepping for meeting, holding sales meetings, forecasting, managing tools, finding leads, prospecting for accounts, and maintaining relations. These are a subset of the nineteen tasks which are identified in FIG. 5 and this subset of tasks grouped to a user sales persona are assigned participant participation numbers by survey participants by a primary job task and a secondary job task for each of the other five particular personas in relation to the sales user persona. For example, the primary job function of a sales leader persona at 620 for managing representatives and the number of survey participants found in this persona group is represented as n=478. The primary job function for a deal closer at 630 for prepping for meeting and holding sales meeting and the number of survey participants found in this persona group is represented as n=930. The primary job function for a data expert at 635 for forecasting and the number of survey participants found in this persona group is represented as n=233. The primary job function for a pipeline builder at 640 for finding quality leads and answering inbounds leads and the number of survey participants found in each this persona group is represented as n=472. Finally, the primary job function for a trusted advisor and the number of survey participants found in each this persona group is represented as n=473 for maintaining relationships.

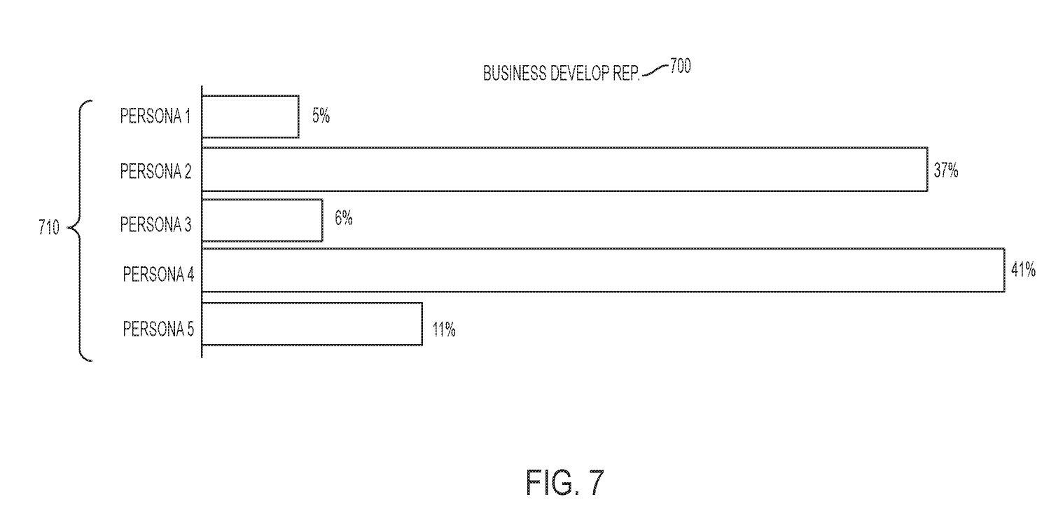

FIG. 7 is an exemplary bar chart illustrating instances when titles do not correspond to personas in the persona identification app system in accordance with an embodiment. In FIG. 7, the bar chart 700 illustrates that the business development representation does not match exactly to a particular persona. In fact, by the computer algorithmic analysis, the business developmental representative has behaviors that map or contribute in percentages to five different personas at 710. In other words, job roles and titles by the analysis do not map directly in a one to one correspondence to particular patterns of behavior and hence, job roles and titles often by the analysis do not map or show a participants actual time spent routinely on job functions.

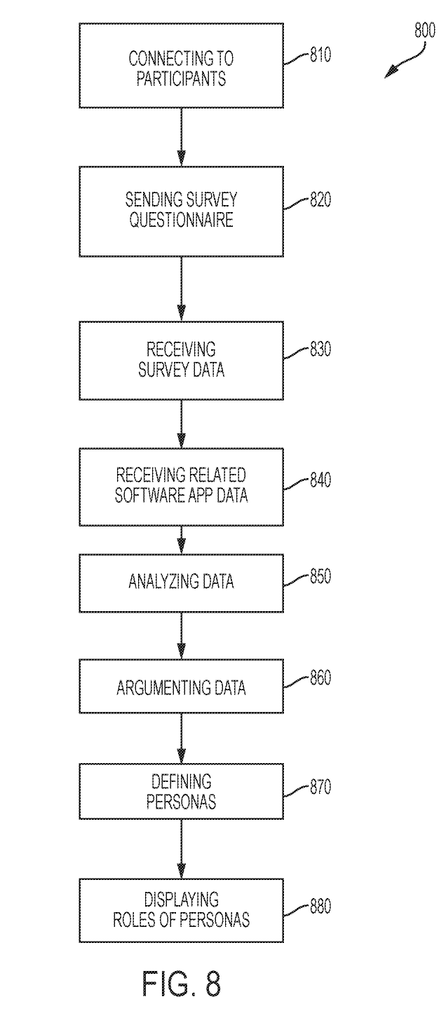

FIG. 8 is an exemplary flowchart of a method illustrating user steps for identifying persona in the persona identification app system in accordance with an embodiment. More particularly, the exemplary method 800 includes the steps of identifying persons as follows: at 810 connecting participants who are identified as subscribers of the software app, by connecting to the participants' mobile devices and to a server hosting the persona identification app; at 820 sending survey questionnaires for data capture to a plurality of mobile devices when executing a cloud or server based persona identification app so each user can fill-out the surveys via mobile devices; at 830, receiving the survey data at the cloud or server based persona identification app; at 840 receiving additional data such at metadata, session data, server access data etc. of the participant use of the software app for use with survey data for more analysis of participant use and behavior while using the software app; at 850 analyzing all the data received for determinations of sets of tasks performed, categories of core behavior attributable to each participant, time spent on each task, and persona which may be identified; at 860, augmenting the received data sets using machine learning, historic data, and artificial intelligence techniques for discovering and modeling data sets and for later use such as accentuating more qualities to the personas which have been defined; at 870, defining the personas for each participant by the participant and subscriber data received and also redefining the roles and titles in accordance with the defined personas; and at 880 displaying the data analysis in various graphic user interfaces for conveniently showing comparisons of which may include the following: the subscriber/participant use, personas defined, primary and secondary job functions, identified core behaviors, prior role descriptions, metrics data received of subscriber and participant use of the software product and comparisons of other employees or roles in an organization. In an exemplary embodiment, the SALESFORCE EINSTEIN™ application may be communicated with to search for and add related information using artificial intelligent and machine language techniques to the data generated from the persona identification app.

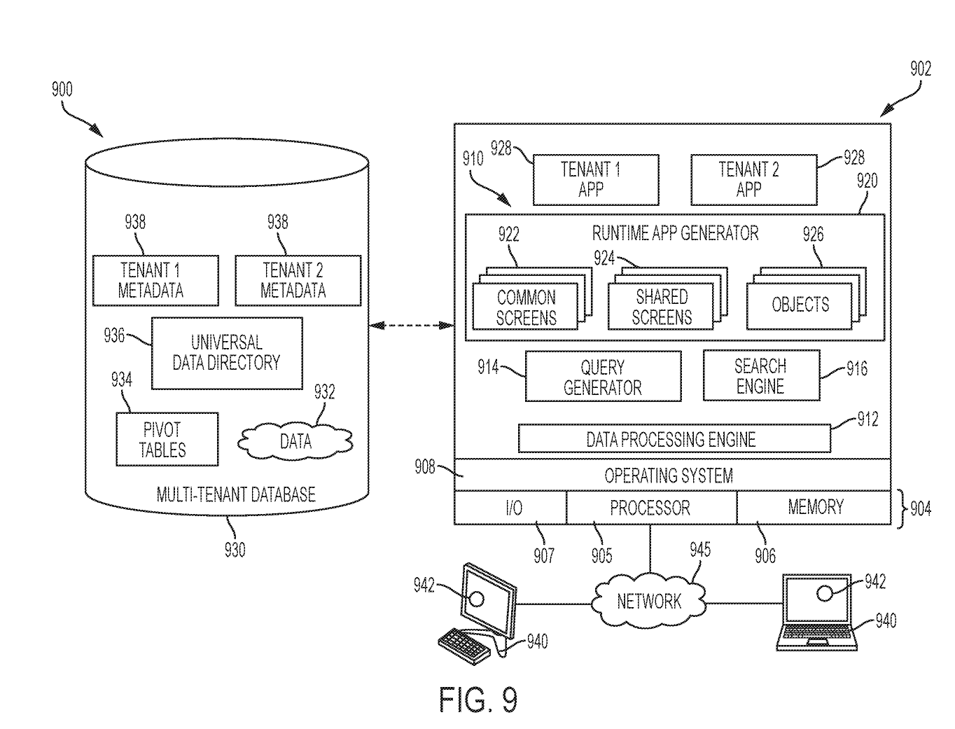

With a reference to FIG. 9, FIG. 9 is a schematic block diagram of a multi-tenant computing environment for use in conjunction with persona identification app system in accordance with an embodiment. A server may be shared between multiple tenants, organizations, or enterprises, referred to herein as a multi-tenant database. In the exemplary disclosure, software app services are provided via a network 945 to any number of tenant devices 940, such as desk tops, laptops, tablets, smartphones, Google Glass™, and any other computing device implemented in an automobile, aircraft, television, or other business or consumer electronic device or system, including web tenants.

Each application 928 is suitably generated at run-time (or on-demand) using a common type of application platform 910 that securely provides access to the data 932 in the multi-tenant database 930 for each of the various tenant organizations subscribing to the service cloud 900. In accordance with one non-limiting example, the service cloud 900 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 930. In this regard, each tenant includes one or more users and/or groups associated with, authorized by, or otherwise belonging to that respective tenant. Stated another way, each respective user within the multi-tenant system of the service cloud 900 is associated with, assigned to, or otherwise belongs to a particular one of the plurality of enterprises supported by the system of the service cloud 900.

Each enterprise tenant may represent a company, corporate department, business or legal organization, and/or any other entities that maintain data for particular sets of users (such as their respective employees or customers) within the multi-tenant system of the service cloud 900. Although multiple tenants may share access to the server 902 and the multi-tenant database 930, the particular data and services provided from the server 902 to each tenant can be securely isolated from those provided to other tenants. The multi-tenant architecture therefore allows different sets of users to share functionality and hardware resources without necessarily sharing any of the data 932 belonging to or otherwise associated with other organizations.

The multi-tenant database 930 may be a repository or other data storage system capable of storing and managing the data 932 associated with any number of tenant organizations. The multi-tenant database 930 may be implemented using conventional database server hardware. In various embodiments, the multi-tenant database 930 shares the processing hardware 904 with the server 902. In other embodiments, the multi-tenant database 930 is implemented using separate physical and/or virtual database server hardware that communicates with the server 902 to perform the various functions described herein.

In an exemplary embodiment, the multi-tenant database 930 includes a database management system or other equivalent software capable of determining an optimal query plan for retrieving and providing a particular subset of the data 932 to an instance of application (or virtual application) 928 in response to a query initiated or otherwise provided by an application 928, as described in greater detail below. The multi-tenant database 930 may alternatively be referred to herein as an on-demand database, in that the multi-tenant database 930 provides (or is available to provide) data at run-time to on-demand virtual applications 928 generated by the application platform 910, as described in greater detail below.

In practice, the data 932 may be organized and formatted in any manner to support the application platform 910. In various embodiments, the data 932 is suitably organized into a relatively small number of large data tables to maintain a semi-amorphous “heap”-type format. The data 932 can then be organized as needed for a particular virtual application 928. In various embodiments, conventional data relationships are established using any number of pivot tables 934 that establish indexing, uniqueness, relationships between entities, and/or other aspects of conventional database organization as desired. Further data manipulation and report formatting is generally performed at run-time using a variety of metadata constructs. Metadata within a universal data directory (UDD) 936, for example, can be used to describe any number of forms, reports, workflows, user access privileges, business logic and other constructs that are common to multiple tenants.

Tenant-specific formatting, functions and other constructs may be maintained as tenant-specific metadata 938 for each tenant, as desired. Rather than forcing the data 932 into an inflexible global structure that is common to all tenants and applications, the multi-tenant database 930 is organized to be relatively amorphous, with the pivot tables 934 and the metadata 938 providing additional structure on an as-needed basis. To that end, the application platform 910 suitably uses the pivot tables 934 and/or the metadata 938 to generate “virtual” components of the virtual applications 928 to logically obtain, process, and present the relatively amorphous data from the multi-tenant database 930.

The server 902 may be implemented using one or more actual and/or virtual computing systems that collectively provide the dynamic type of application platform 910 for generating the virtual applications 928. For example, the server 902 may be implemented using a cluster of actual and/or virtual servers operating in conjunction with each other, typically in association with conventional network communications, cluster management, load balancing and other features as appropriate. The server 902 operates with any sort of processing hardware 904 which is conventional, such as a processor 905, memory 906, input/output features 907 and the like. The input/output features 907 generally represent the interface(s) to networks (e.g., to the network 945, or any other local area, wide area or other network), mass storage, display devices, data entry devices and/or the like.

The processor 905 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 906 represents any non-transitory short or long term storage or other computer-readable media capable of storing programming instructions for execution on the processor 905, including any sort of random access memory (RAM), read only memory (ROM), flash memory, magnetic or optical mass storage, and/or the like. The computer-executable programming instructions, when read and executed by the server 902 and/or processors 905, cause the server 902 and/or processors 905 to create, generate, or otherwise facilitate the application platform 910 and/or virtual applications 928 and perform one or more additional tasks, operations, functions, and/or processes described herein. It should be noted that the memory 906 represents one suitable implementation of such computer-readable media, and alternatively or additionally, the server 902 could receive and cooperate with external computer-readable media that is realized as a portable or mobile component or platform, e.g., a portable hard drive, a USB flash drive, an optical disc, or the like.

The application platform 910 is any sort of software application or other data processing engine that generates the virtual applications 928 that provide data and/or services to the tenant devices 940. In a typical embodiment, the application platform 910 gains access to processing resources, communications interface and other features of the processing hardware 904 using any sort of conventional or proprietary operating system 908. The virtual applications 928 are typically generated at run-time in response to input received from the tenant devices 940. For the illustrated embodiment, the application platform 910 includes a bulk data processing engine 912, a query generator 914, a search engine 916 that provides text indexing and other search functionality, and a runtime application generator 920. Each of these features may be implemented as a separate process or other module, and many equivalent embodiments could include different and/or additional features, components or other modules as desired.

The runtime application generator 920 dynamically builds and executes the virtual applications 928 in response to specific requests received from the tenant devices 940. The virtual applications 928 are typically constructed in accordance with the tenant-specific metadata 938, which describes the particular tables, reports, interfaces and/or other features of the particular application 928. In various embodiments, each virtual application 928 generates dynamic web content that can be served to a browser or other tenant program 942 associated with its tenant device 940, as appropriate.

The runtime application generator 920 suitably interacts with the query generator 914 to efficiently obtain data 932 from the multi-tenant database 930 as needed in response to input queries initiated or otherwise provided by users of the tenant devices 940. In a typical embodiment, the query generator 914 considers the identity of the user requesting a particular function (along with the user's associated tenant), and then builds and executes queries to the multi-tenant database 930 using system-wide metadata 936, tenant specific metadata, pivot tables 934, and/or any other available resources. The query generator 914 in this example therefore maintains security of the common database by ensuring that queries are consistent with access privileges granted to the user and/or tenant that initiated the request.

With continued reference to FIG. 9, the bulk data processing engine 912 performs bulk processing operations on the data 932 such as uploads or downloads, updates, online transaction processing, and/or the like. In many embodiments, less urgent bulk processing of the data 932 can be scheduled to occur as processing resources become available, thereby giving priority to more urgent data processing by the query generator 914, the search engine 916, the virtual applications 928, etc.

In exemplary embodiments, the application platform 910 is utilized to create and/or generate data-driven virtual applications 928 for the tenants that they support. Such virtual applications 928 may make use of interface features such as custom (or tenant-specific) screens 924, standard (or universal) screens 922 or the like. Any number of custom and/or standard objects 926 may also be available for integration into tenant-developed virtual applications 928. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 932 associated with each virtual application 928 is provided to the multi-tenant database 930, as appropriate, and stored until it is requested or is otherwise needed, along with the metadata 938 that describes the particular features (e.g., reports, tables, functions, objects, fields, formulas, code, etc.) of that particular virtual application 928. For example, a virtual application 928 may include a number of objects 926 accessible to a tenant, wherein for each object 926 accessible to the tenant, information pertaining to its object type along with values for various fields associated with that respective object type are maintained as metadata 938 in the multi-tenant database 930. In this regard, the object type defines the structure (e.g., the formatting, functions and other constructs) of each respective object 926 and the various fields associated therewith.

Still referring to FIG. 9, the data and services provided by the server 902 can be retrieved using any sort of personal computer, mobile telephone, tablet or other network-enabled tenant device 940 on the network 945. In an exemplary embodiment, the tenant device 940 includes a display device, such as a monitor, screen, or another conventional electronic display capable of graphically presenting data and/or information retrieved from the multi-tenant database 930, as described in greater detail below.

Typically, the user operates a conventional browser application or other tenant program 942 executed by the tenant device 940 to contact the server 902 via the network 945 using a networking protocol, such as the hypertext transport protocol (HTTP) or the like. The user typically authenticates his or her identity to the server 902 to obtain a session identifier (“Session ID”) that identifies the user in subsequent communications with the server 902. When the identified user requests access to a virtual application 928, the runtime application generator 920 suitably creates the application at run time based upon the metadata 938, as appropriate. However, if a user chooses to manually upload an updated file (through either the web based user interface or through an API), it will also be shared automatically with all of the users/devices that are designated for sharing.

As noted above, the virtual application 928 may contain Java, ActiveX, or other content that can be presented using conventional tenant software running on the tenant device 940; other embodiments may simply provide dynamic web or other content that can be presented and viewed by the user, as desired. As described in greater detail below, the query generator 914 suitably obtains the requested subsets of data 932 from the multi-tenant database 930 as needed to populate the tables, reports or other features of a particular virtual application 928. In various embodiments, application 928 embodies the functionality of an interactive performance review template linked to a database of performance metrics, as described below in a connection with FIGS. 1-8.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 9 depicts one exemplary arrangement of elements, additional intervening elements, devices, features, or components may be present in an embodiment of the depicted subject matter.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with viewing, object identification, sharing and information retrieving processes between the mobile client and agent in video-chat applications may be performed by software, hardware, firmware, or any combination thereof. For illustrative purposes, the following description of data capture, behavior, roles, tasks, functions, survey, persona, and process may refer to elements mentioned above in connection with FIGS. 1-9. In practice, portions of process of FIGS. 1-9 may be performed by different elements of the described system, e.g., mobile clients, server, cloud, in-app applications etc.

It should be appreciated that process of FIGS. 1-9 may include any number of additional or alternative tasks, the tasks shown in FIGS. 1-9 need not be performed in the illustrated order, and process of the FIGS. 1-9 may be incorporated into a more comprehensive procedure or process having additional functionality not described in detail herein. Moreover, one or more of the tasks shown in FIGS. 1-9 could be omitted from an embodiment of the process shown in FIGS. 1-9 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for determining functional roles of participants within an organization based on use by each participant of a software product for identifying a persona related to a participant role, said method comprising:
generating a survey for identifying a plurality of tasks performed by each participant using the software product independent of a role defined for the participant in an organization wherein the role has been previously defined based on a set of similar functionalities by the organization for the participant;
receiving data by the survey from a set of responses related to tasks of the participant use of the software product and not in accordance with the set of similar functionalities defined by the organization;
quantifying the data of the survey into clusters using algorithmic solutions for associating the clusters with core behaviors of each of the participants to redefine a role of the participant by tasks performed based on the participant use of the software product; and
determining, from a plurality of personas, a particular persona to be associated with each participant in accordance with a redefined role of the participant in the organization wherein the redefined role is based on results of associated core behaviors and related tasks performed of the participant.

2. A method of claim 1, wherein the software product comprises a software-as-a-service (SaaS) application.

3. The method of claim 1, wherein the software product comprises a cloud application.

4. The method of claim 1, further comprising:
receiving data of participants' use other than the survey data for quantifying into clusters with the survey data, and for associating with the core behaviors wherein the core behaviors are in turn associated with redefined roles of participants in the organization.

5. The method of claim 4, further comprising:
applying machine learning and artificial intelligent techniques to augment the survey data for better modeling of the redefined roles of the participants by use of machine learning and artificial intelligent applications to assist in both accentuating a data set of participant use for each participant and in formulating the redefined roles.

6. The method of claim 1, further comprising:
identifying time for one or more of each task of the plurality of tasks of participants in particular roles in the organization to differentiate participant roles based on time spent for each task and for allotting numerical scores for the time spent in association with a function of each task of the plurality of tasks identified.

7. The method of claim 1, further comprising:
identifying one or more personas from the plurality of personas for association with each of the participants wherein each participant is assigned a percentage contribution to an individual persona.

8. The method of claim 7, further comprising:
accessing knowledge databases or multi-tenant databases for data using artificial intelligence, machine learning and history of participant use to accentuate the individual persona.

9. A computer program product tangibly embodied in a computer-readable storage device and comprising instructions configurable to be executed by a processor to perform a method for determining functional roles of participants within an organization based on use by each participant of a software product for identifying a persona related to a participant role, the method comprising:
generating a survey for identifying a plurality of tasks performed by each participant using the software product independent of a role defined for the participant in an organization wherein the role has been previously defined based on a set of similar functionalities by the organization for the participant;
receiving data by the survey from a set of responses related to tasks of the participant use of the software product and not in accordance with the set of similar functionalities defined by the organization;
quantifying the data of the survey into clusters using algorithmic solutions for associating the clusters with core behaviors of each of the participants to redefine a role of the participant by tasks performed based on the participant use of the software product; and
determining, from a plurality of personas, a particular persona to be associated with each participant in accordance with a redefined role of the participant wherein the redefined role is based on results of associated core behaviors and related tasks performed of the participant in the organization.

10. The method of claim 9 wherein the software product comprises a software-as-a-service (SaaS) application.

11. The method of claim 9 wherein the software product comprises a cloud application.

12. The method of claim 9, further comprising:
receiving data of participants use other than the survey data for quantifying into clusters with the survey data, and for associating with the core behaviors wherein the core behaviors are in turn associated with redefined roles in the organization.

13. The method of claim 12, further comprising:
applying machine learning and artificial intelligent techniques to augment the survey data for better modeling of the redefined roles of the participants by use of machine learning and artificial intelligent applications to assist in both accentuating a data set of participant use for each participant and in formulating the redefined roles.

14. The method of claim 9 further comprising:
identifying time for one or more of each task of the plurality of tasks of participants in particular roles in the organization to differentiate participant roles based on time spent for each task and for allotting numerical scores for the time spent in association with a function of each task of the plurality of tasks identified.

15. The method of claim 9, further comprising:
identifying one or more personas from the plurality of personas for association with each of the participants wherein each participant is assigned a percentage contribution to an individual persona.

16. The method of claim 15, further comprising:
accessing knowledge databases or multi-tenant databases for data using artificial intelligence, machine learning and history of participant use to accentuate the individual persona.

17. A system comprising:
at least one processor; and
at least one computer-readable storage device comprising instructions configurable to be executed by the at least one processor to perform a method for identifying a persona of an employee of an organization by session use of a cloud application, the method comprising:
generating a survey for identifying a plurality of tasks performed by each employee using the cloud application independent of a role defined for the employee in an organization wherein the role has been previously defined based on a set of similar functionalities by the organization for the employee;
receiving data by the survey from a set of responses related to tasks of the participant use of the software product and not in accordance with the set of similar functionalities defined by the organization;
quantifying the data of the survey into clusters using algorithmic solutions for associating the clusters with core behaviors of each of the participants to redefine a role of the employee by tasks performed based on the employee use of the software product; and
determining, from a plurality of personas, a particular persona to be associated with each employee in accordance with a redefined role of the employee wherein the redefined role is based on results of associated core behaviors and related tasks performed of the employee in the organization.

18. The system of claim 17, further comprising:
receiving data of employee use other than the survey data for quantifying into clusters with the survey data, and for associating with the core behaviors wherein the core behaviors are in turn associated with redefined roles in the organization.

19. The system of claim 17, further comprising:
identifying time for one or more of each task of the plurality of tasks of employees in particular roles in the organization to differentiate employee roles based on time spent for each task and for allotting numerical scores for the time spent in association with a function of each task of the plurality of tasks identified.

20. The system of claim 17, further comprising:
identifying one or more personas from the plurality of personas for association with each of the employees wherein each employee is assigned a percentage contribution to an individual persona.
